(19) United States
(12) Patent Application Publication
(10) Pub. No.: US 2007/0163394 A1
(43) Pub. Date: Jul. 19, 2007

(54) Housing structure for a motor

(75) Inventor: Zheng Zhang, Shanghai (CN)

Correspondence Address: BIRCH STEWART KOLASCH & BIRCH, PO BOX 747, FALLS CHURCH, VA, 22040-0747, US

(73) Assignee: Inventec Appliances Corporation

(21) Appl. No.: 11/636,576

(22) Filed: Dec. 11, 2006

(30) Foreign Application Priority Data
Jan. 18, 2006 (TW) 95201112

(51) Int. Cl. H02G 1/12

(52) U.S. Cl. 81/9.51

(57) ABSTRACT

A housing structure for a motor with leads includes a frame and a sheathing member. The frame is disposed in the housing, and the sheathing member is disposed in the frame. The sheathing member contains the motor with leads. The frame and the sheathing member limit the motor, such that the motor is fixed in the frame, effectively preventing the motor from loosening in the frame, or falling out of the frame.

### FIELD OF THE INVENTION

The invention relates to a housing structure for a motor, and more particularly, to a housing comprising a frame having a sheathing member disposed therein, wherein the sheathing member is for containing the motor.

### DESCRIPTION OF THE RELATED ART

The world's information technology and electronic industry are getting prosperous. Hi-tech products, telecommunication products and communication technology are in progress, leading current electronic device design trending toward compact size, multiple functionality and low price. However, mobile phones are among the most popular and widely used electronic devices. The widely used mobile phones indeed minimize the time difference and the space distance between each individual. However, high demand of new mobile phones is requested in the market. Provision of convenience, efficiency, functionalities and services for mobile phones becomes critical standard when evaluating the manufacturing technology. Thus, mobile phone manufacturers keep continually adding new features in an effort to gain market competition.

Many mobile phones provide ring tones and ring tone editing features. Ring tones are stored in a storage medium of a mobile phone. A software player plays the ring tone when an incoming call is received. When the mobile phone receives electrical signals, the software player reads the ring tone data, transforming the data into melodies, such as pop music, cartoon music or classical music. The melodies are then output by a speaker.

Loud or musical ring tones are not suitable in every situation. For example, a mobile phone may be switched to a silent mode when in a class or in a meeting, potentially resulting in missed calls. Many conventional mobile phones provide a motor for powering a vibrator function. Referring to FIG. 1, a housing 1 of the mobile phone comprises frame 10 for containing a motor 2. The motor 2 comprises a body 20, a drive shaft 22, a vibrator 24 and two elastic plates 26, wherein the body 20 is contained in the frame 10. The drive shaft 22 extends outward from an end of the body 20. The vibrator 24 is disposed on the drive shaft 22, away from the body 20. The two elastic plates 26 are disposed on a surface of the body 20, opposite to the frame 10, allowing the elastic plates 26 to connect with two connecting points of a circuit board. The motor 2 then electrically couples to the circuit board.

When the mobile phone receives signals, the motor 2 is actuated through the two connecting points. The motor 2 rotates the vibrator 24, vibrating the cell phone. Thus, the mobile phone vibrates when an incoming call is received while the mobile phone is set to silent mode. In a conventional design, however, the motor 2 is placed between the housing 1, the frame 10 and the circuit board, thus occupying space on the circuit board, hindering miniaturization. To solve this problem, the elastic plates 26 of the motor 2 are switched to leads. Because a motor with leads does not abut a circuit board, the motor 2 is easily loosened within the frame 10, causing abnormal vibration and noise. Thus, a mobile phone capable of ameliorating the described disadvantages is desirable.

### SUMMARY OF THE INVENTION

To improve the disadvantages such as wasting spaces of a circuit board with use of elastic plates, or loose disposition of the motor in the frame with use of leads, a housing structure for a motor with leads is provided.

An exemplary embodiment of a motor with leads comprises a housing structure comprising: a frame and a sheathing member. The sheathing member is disposed in the housing, and the sheathing member is disposed in the frame. The motor with leads is disposed in the sheathing member, thus, the motor is fixed in the frame. The frame and the sheathing member limit movement of the motor to prevent loosening.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional mobile phone with a motor; and

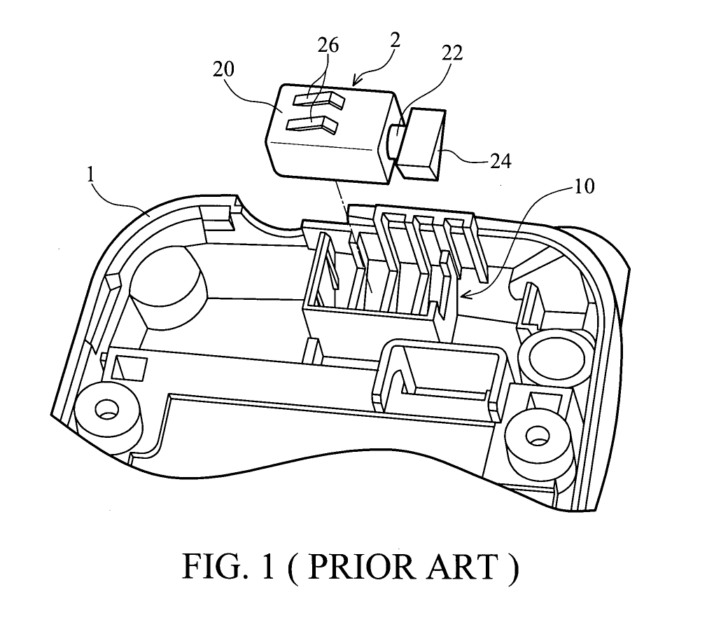

FIG. 2 is a schematic view of a housing structure of the invention.

### DETAILED DESCRIPTION OF THE INVENTION

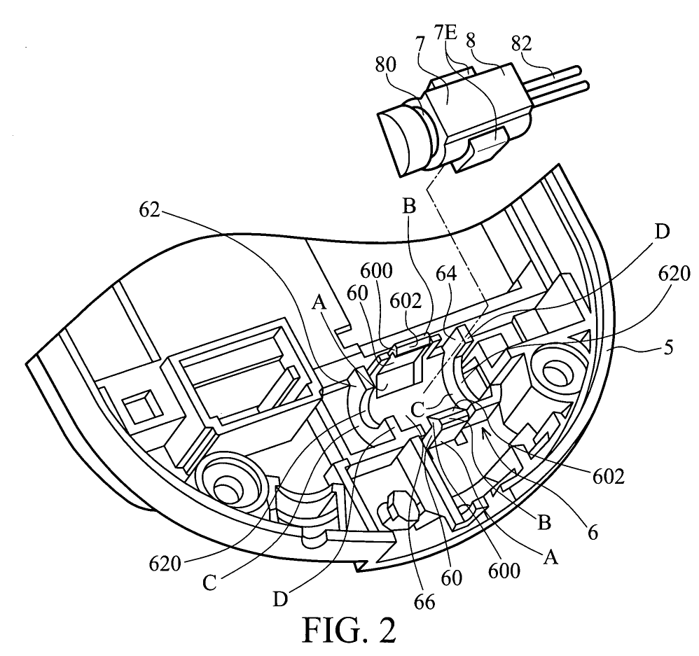

The invention provides a housing structure for a motor with leads. Referring to FIG. 2, the housing structure comprises a frame 6 and a sheathing member 7. The frame 6 is disposed in a housing 5, and the sheathing member 7 is disposed in the frame 6. The sheathing member 7 contains the motor 8 with leads. The frame 6 and the sheathing member 7 limit the motor 8, such that the motor 8 is fixed in the frame 6, effectively preventing the motor 8 from loosening, or falling out of frame 6.

Referring to FIG. 2 again, the frame 6 comprises two engaging members 60, a first rib 62 and a second rib 64, wherein the two engaging members 60 are disposed on a surface of the housing 5 face to face. The two engaging members 60 comprise a first side and a second side. The first rib 62 is disposed on and connected with the first side of the two engaging members 60, and the second rib 64 is disposed on and connected with the second side of the two engaging members 60, allowing the sheathing member 7 and the motor 8 to be contained between the two engaging members 60, the first rib 62, and the second rib 64. That is, the motor 8 is stably fixed and engaged in the frame 6, preventing the motor 8 from falling out of the frame 6.

Referring to FIG. 2 again, each of the two engaging members 60 comprises a first end A and a second end B. The first ends A of the engaging members 60 are disposed on the surface of the housing 5, and the second ends B of the engaging members 60 are extended toward an opposite direction of the housing 5 and away from the the housing 5, wherein the second ends B of the engaging members 60 respectively comprise hooks 600, extending toward each other face to face. When the motor 8 is disposed in the frame 6, the hooks 600 of the engaging members 60 fix the motor 8 in the frame 6, preventing the motor 8 from loosening or falling out of the frame 6.

Referring to FIG. 2 again, the sheathing member 7 comprises two ends 7E. The two ends 7E of sheathing member 7 extend toward the second ends B of the engaging members 60, respectively, tightly adjacent to the second ends B of the engaging member 60. The two ends 7E of the sheathing member 7 are bent inward toward frame 6 to contain the motor 8. As a result, when the motor 8 is disposed in the frame 6, the sheathing member 7 is contained between the motor 8 and the two engaging members 60, and the two ends 7E of the sheathing members 7 are tightly adjacent to the two hooks 600 of the two engaging members 60. The motor 8 is restrained by the hooks 600, preventing the motor 8 from loosening or falling out of the frame 6 thus causing abnormal vibration.

Referring to FIG. 2 again, the hooks 600 comprise a slanted surface 602 opposite to the surface of the housing 5, extending from the top of the engaging members 60 to the surface of the housing 5. When installing the motor 8 in the frame 6, the motor 8 can be easily pushed between the two engaging members 60.

Referring to FIG. 2 again, each of the first rib 62 and the second rib 64 comprises a third end C and a fourth end D. The third ends C of the first rib 62 and the second rib 64 are disposed on the surface of the housing 5, and the fourth ends D of the first rib 62 and the second rib 64 are extended toward an opposite direction of the housing 5 and away from the housing 5. The fourth ends D of the first rib 62 and the second rib 64 comprise notches 620, respectively, allowing a drive shaft 80 and a connecting line 82 of the motor 8 to pass through. As a result, a vibrator disposed on an end of the drive shaft 80, on one end of the motor 8, rotates outside the frame 6, and the connecting line 82, on another end of the motor 8, connects to a connector disposed on the housing 5.

Referring to FIG. 2 again, the housing 5 comprises a depression 66 between the first rib 62, the second rib 64 and the two engaging members 60. Two ends of the depression 66 extend toward the third ends C of the first rib 62 and the second rib 64, containing the motor 8 in the depression 66.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A housing structure of a motor with leads for an electronic device, comprising:
a housing;
a frame disposed in the housing; and
a sheathing member disposed in the frame, sheathing the motor with leads.

2. The housing structure as claimed in claim 1, wherein the frame comprises: two engaging members disposed on a surface of the housing, opposite to each other, and comprising a first side and a second side;
a first rib disposed on and connected with the first side of the engaging members; and
a second rib disposed on and connected with the second side of the engaging members;
wherein the motor and the sheathing member are contained between the engaging members, the first rib and the second rib.

3. The housing structure as claimed in claim 2, wherein the two engaging members comprises first ends and second ends the first ends of the engaging members are disposed on the surface of the housing, the second ends of the engaging members are extended toward an opposite direction of the housing and away from the housing, and the second ends of the engaging members comprise hooks connected thereto, extending toward each other.

4. The housing structure as claimed in claim 3, wherein the sheathing member comprises two ends, the two ends of the sheathing member extend toward the second ends of the engaging members respectively, adjacent to the hooks on the second ends of the engaging members, the two ends of the sheathing member are bent inward toward the frame, containing the motor.

5. The housing structure as claimed in claim 4, wherein the first rib and the second rib comprise third ends and fourth ends, the third ends of the first rib and the second rib are disposed on the surface of the housing, the fourth ends of the first ribs and the second rib are extended away from the housing, the fourth ends of the first rib and the second rib comprise notches, respectively, allowing passage of a drive shaft and a connecting line of the motor.

6. The housing structure as claimed in claim 5, wherein the housing comprises a depression with two ends between the first rib, the second rib and two engaging members, the two ends of the depression extend toward the third ends of the first rib and the second rib.

7. The housing structure as claimed in claim 3, wherein the hooks comprise a slanted surface opposite to the surface of the housing.
